(19) United States
(12) Patent Application Publication
(10) Pub. No.: US 2026/0147973 A1
(43) Pub. Date: May 28, 2026

(54) FONT REPLACEMENT BASED ON LAYOUT

(71) Applicant: Adobe Inc., San Jose, CA (US)

(72) Inventors: Ashish Jain, Ashok Vihar (IN); Sanyam Jain, New Delhi (IN); Rishav Agarwal, Panathur (IN)

(73) Assignee: Adobe Inc., San Jose, CA (US)

(21) Appl. No.: 18/959,573

(22) Filed: Nov. 25, 2024

(51) Int. Cl. G06F 40/109; G06V 30/418

(52) U.S. Cl. CPC G06F 40/109; G06V 30/418

(57) ABSTRACT

Font replacement techniques based on layout are described. In one or more examples, a document is received including a font and font metadata, the font metadata indicating a layout of text using the font in the document. The font is detected as unavailable and one or more fonts are selected from a plurality of fonts based on the layout of the text indicated by the font metadata. The one or more fonts are presented in a user interface to replace the font as used for the text in the document.

### BACKGROUND

When opening a document created on another computing device or in a different application, designers and editors often find one or more fonts in the original document are not available on the current computer or application. In such scenarios, conventional techniques replace the missing font with a default or similar available font.

However, this substitution can introduce unintended changes in the generated document, altering the document's appearance and text layout. As a result, adjusting the document, such as finding a different font to match the original font better or editing the content to restore the original design, can be time-consuming and frustrating. These challenges are compounded when multiple users collaborate on the same document, each with potentially different fonts available.

### SUMMARY

Techniques and systems are described for font replacement based on layout. In one example, a computing device implements a font replacement module to identify one or more fonts that result in a visually similar layout. The computing device receives a document that includes a font and font metadata. The font metadata includes an indication of text layout using the font in the document. For example, the font metadata includes an image of text using the font in a prominent paragraph, line, or word. Prominence can be determined using font size, character count, word count, or usage area.

While opening or storing the document, the font replacement module identifies the font is unavailable. The font replacement module selects one or more fonts to replace the font based on the text layout indicated in the font metadata. For example, the fonts are determined based on a visual comparison between the image in the font metadata and a replacement image of the same text using the fonts. The fonts are sorted based on a visual similarity metric or matching score in one implementation. The fonts are then presented via a user interface as potential replacements for the font. The user interface can also indicate the matching score for each font. After receiving a selection of a replacement font, the font replacement module presents the document via the user interface with the replacement font.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques to provide font replacement based on layout as described herein.

FIG. 2 depicts a system in an example implementation showing an operation of a font replacement module to provide font replacement based on layout.

FIG. 3 is a flow diagram depicting a procedure in an example implementation showing an operation of a font metadata module to generate font metadata to support font replacement based on layout.

FIG. 4 is a flow diagram depicting a procedure in an example implementation showing the generation replacement fonts based on layout.

FIG. 5 illustrates an example user interface for providing font replacements based on layout for missing fonts to a user.

FIGS. 6 through 13 illustrate comparisons of traditional substitution suggestions versus layout-based font suggestions for missing fonts in comparison to the missing font in an original document.

FIG. 14 is a flow diagram depicting a procedure in an example implementation for font replacement based on layout.

FIG. 15 illustrates an example system that includes an example computing device that is representative of one or more computing systems and/or devices for implementing the various techniques described herein.

### DETAILED DESCRIPTION

### Overview

Designers and editors often find one or more fonts in an original document unavailable on a current computer or application when opening a document created on another computer or in a different application. Similar missing font scenarios can occur in other scenarios, for example, after an application update or when collaborating with other designers. In these scenarios, conventional techniques replace the missing font with a similar font. However, this substitution can introduce unintended changes, altering the document's appearance and text layout. For example, the replacement font can cause the text content to flow differently inside the corresponding text frame due to either changes in line heights or letter widths. As a result, adjusting the document is time-consuming, such as to find a different font that is a better match to the original font or edit the content to restore the original design.

Accordingly, techniques for font replacement based on layout techniques are described that support the generation of font suggestions that minimize potential changes to the document's appearance and layout. Unlike conventional approaches, the described techniques consider the design and layout information of the corresponding text in determining one or more recommendations for font substitutions. In this way, the recommended font substitutions are visually similar to the missing font, and the affected text closely matches the visual layout of the original document to ensure minimal to no changes. In one implementation, the recommendations indicate a matching score that compares the font and text quantitively to assist users in selecting a replacement font.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Document Environment

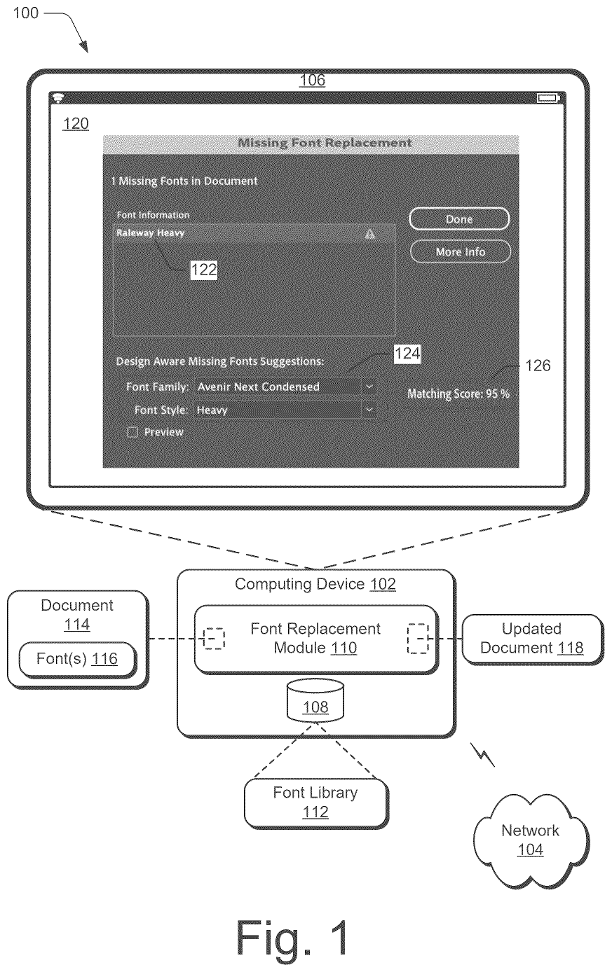

FIG. 1 is an illustration of an environment 100 in an example implementation that is operable to employ digital systems and techniques to provide font replacement based on layout as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full-resource device with substantial memory and processor resources (e.g., personal computers and game consoles) to a low-resource device with limited memory and/or processing resources (e.g., mobile devices). In some examples, the computing device 102 is representative of a plurality of different devices, such as multiple servers utilized to perform operations “in the cloud.”

The illustrated environment 100 also includes a display device 106 that is communicatively coupled to the computing device 102 via a wired or wireless connection. Various device configurations are usable to implement the computing device 102 and/or the display device 106. The computing device 102 includes a storage device 108 and a font replacement module 110. The storage device 108 is illustrated to include a font library 112.

The font library 112 includes multiple available fonts, allowing users to create digital content with a variety of fonts that have different styles and appearances. The font replacement module 110 utilizes the font library 112 to identify and recommend one or more replacement fonts that visually match a missing font with a similar text layout.

The font replacement module 110 is illustrated as having and/or receiving a document 114 with one or more fonts 116. The document 114 includes a static or non-static digital artwork (e.g., a document, presentation, video, flyer, etc.) of text, icons, images, logos, and other digital content with the text, images, logos, and similar content in the one or more fonts 116. In response to the user opening the document 114, the font replacement module 110 (or another module associated with a content creation and editing application) analyzes the document 114 to determine if one or more fonts 116 are unavailable.

In response to one or more missing fonts 122, the font replacement module 110 extracts (e.g., in the background and unseen to the user) metadata associated with the one or more missing fonts 122 stored with the document 114. Using the metadata, the font replacement module 110 determines a list of suggested fonts for each missing font 122. For each missing font 122, the suggested fonts are ranked based on the design and layout aspects of the document 114. The font replacement module 110 also causes a missing font dialog box or other notification to appear on a user interface 120. For example, user interface 120 is a user interface of the application for editing digital content, and the dialog box is displayed in the user interface of the application.

In one implementation, the top recommended substitute font 124 for each missing font 122 is displayed in the dialog box as the default suggestion. The dialog box can also include a ranking score 126 for each recommended substitute font, with the ranking score 126 indicating how similar the font itself and the corresponding text is to the missing font and the corresponding text in the document 114, respectively. In this way, the user saves time and effort in finding a replacement font for each missing font and editing the content to match the design and layout of the original document 114. Once the user selects or confirms the replacement font(s), the font replacement module 110 generates an updated document 118 with the replacement fonts.

In an example, a user interacts with an input device (e.g., a mouse, a stylus, a keyboard, a touchscreen, a microphone, etc.) relative to the user interface 120 to select a replacement font for each missing font 122. In this example, the user manipulates the input device relative to the user interface 120 to select the replacement font(s) based on the ranking score 126 and/or an image preview of the updated document 118 with the currently selected replacement font(s). After the replacement fonts are selected and/or confirmed by the user via the dialog box, the font replacement module 110 generates and presents the updated document 118 with the replacement fonts to the user via the user interface 120.

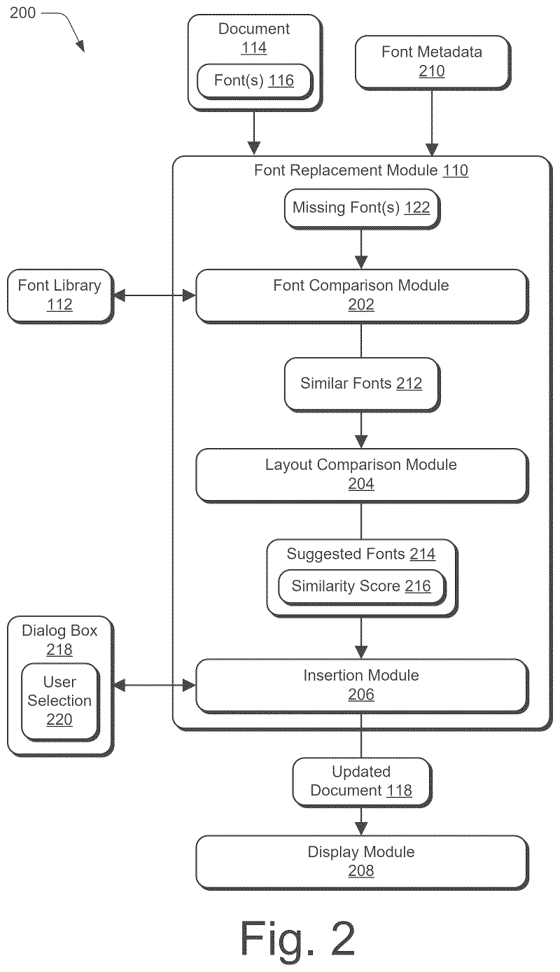

FIG. 2 depicts a system 200 in an example implementation showing an operation of a font replacement module 110 to provide font replacement suggestions based on layout. The font replacement module 110 is illustrated to include a font comparison module 202, a layout comparison module 204, and an insertion module 206 and is operatively connected to a display module 208. The font replacement module 110 receives document 114, which includes one or more fonts 116. Document 114 describes or includes one or more digital documents or artworks.

The font replacement module 110 also receives font metadata 210 for each font 116, which is generated during document creation (e.g., on a computer or in an application that generated or saved the document 114) and includes an image of each font 116 from a prominent region of the document 114. The font metadata 210 ensures that the font replacement module 110 (e.g., on a different computer or application) can provide design-aware substitution suggestions for any missing fonts. In one implementation, the font metadata 210 is cached or otherwise stored within or as part of the document 114.

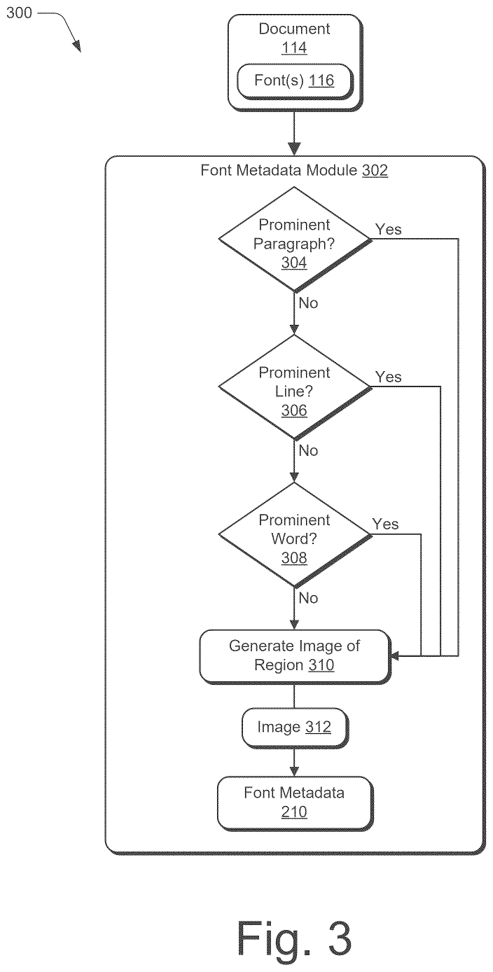

FIG. 3 is a flow diagram depicting a procedure 300 in an example implementation showing an operation of a font metadata module 302 to generate font metadata 210 to support font replacement based on layout. During the creation or saving of document 114, the font metadata module 302 generates the font metadata 210 for each font 116 in document 114. The font metadata module 302 receives, finds, creates, and/or maintains a list of the fonts 116 used within the document 114. For each font 116, the font metadata module 302 determines an area-wise distribution of the font 116 within document 114.

Based on the area-wise distribution, the font metadata module 302 determines whether the most prominent paragraph solely using font 116 is present in document 114 (block 304). Font size, the number of characters, the number of words, or area usage can be used to determine prominence in document 114 for each font 116. If a most prominent paragraph that solely uses the font 116 is not present in document 114 (e.g., a “no” determination at block 304), the font metadata module 302 determines whether the most prominent line solely using font 116 is present in document 114 (block 306). If a most prominent line that solely uses font 116 is not present in document 114 (e.g., a “no” determination at block 306), the font metadata module 302 determines whether the most prominent word solely using font 116 is present in document 114 (block 308). In other implementations, the font metadata module 302 makes the determinations at blocks 304, 306, and 308 based on regions that use font 116 above a certain threshold (e.g., a predefined percentage) and does not require the font 116 to be solely used in the region under consideration.

In response to identifying the paragraph, line, or word solely using the font 116 (e.g., a “yes” determination at blocks 304, 306, or 308), the font metadata module 302 generates an image 312 of the region (e.g., the corresponding paragraph, line, or word from blocks 304, 306, or 308) (block 310). For example, a screenshot of the region along with the (physical) bounds of the region are saved as the font metadata 210 for each font 116. The font metadata 210 is saved, stored, or cached with document 114 with an association between each font 116 and its associated font metadata 210.

Returning to system 200 of FIG. 2, the font replacement module 110 receives document 114, which includes one or more fonts 116 and associated font metadata 210. The font replacement module 110 (or another component associated with computing device 102 or the specific application) identifies one or more missing fonts 122, which are unavailable or unsupported by the application and/or computing device 102. The font comparison module 202 finds, receives, or otherwise obtains the missing fonts 122 and determines one or more similar fonts 212. In particular, the font comparison module 202 uses the font library 112 to determine one or more similar fonts 212 for each missing font 122. For example, the font comparison module identifies the top 80 (or another integer value) of similar fonts 212 for each missing font 122.

For each missing font 122, the layout comparison module 204 analyzes the visual similarity of each similar font 212 to identify one or more suggested fonts 214 to replace the missing font 122. The layout comparison module 204 uses image 312 and other font metadata 210 to assess the visual similarity of each similar font 212 and determine a similarity score 216 to quantify the visual similarity. The visual similarity analysis can consider typesetting details such as kerning, tracking, line spacing, leading, line flows, and other visual characteristics. The similar fonts 212 are ranked based on their similarity scores 216 to generate an ordered or sorted list of suggested fonts 214.

The insertion module 206 presents a subset of the suggested fonts 214 along with the corresponding similarity scores 216 for each missing font 122 in a dialog box 218 in the user interface 120. As described above, the user provides a user selection 220 of the replacement font for each missing font 122 via the dialog box 218. In response to the user selection 220, the insertion module 206 substitutes the missing fonts 122 with the replacement fonts and generates the updated document 118. The display module 208 receives and processes the updated document 118 and displays the updated document 118 with the replacement fonts in the user interface 120.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

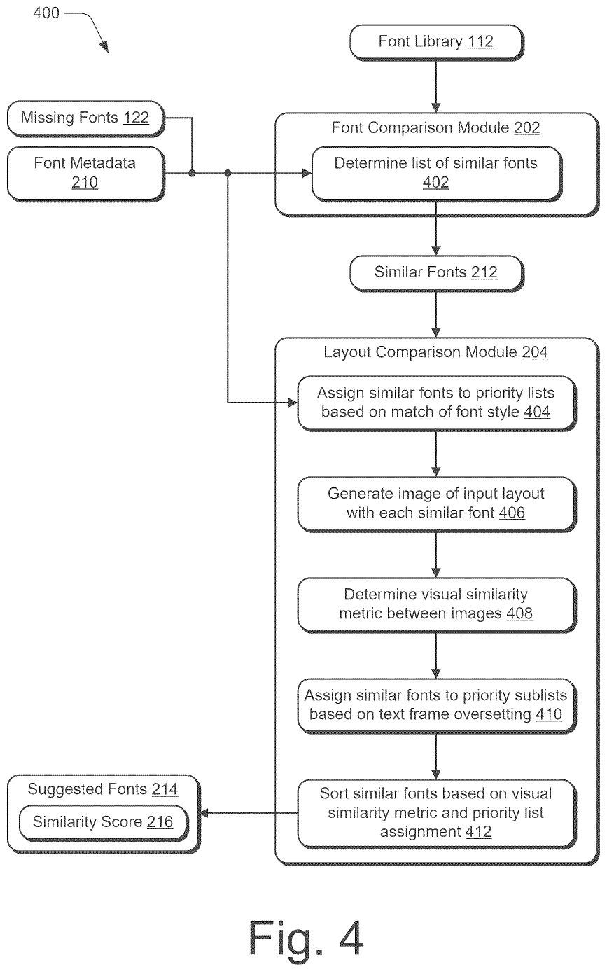

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-3. FIG. 4 is a flow diagram depicting a procedure 400 in an example implementation showing the generation of font replacement suggestions based on layout.

Inputs to the font comparison module 202 include the font library 112, the missing fonts 122, and the font metadata 210. As described above, the font metadata includes one or more images 312 of the missing fonts 122 in document 114. The font comparison module 202 uses images 312 to determine a list of similar fonts 212 from among the font library 112 (block 402). In one implementation, the font comparison module 202 identifies the 80 most similar fonts 212 for each missing font 122. In other implementations, a different number of similar fonts 212 is determined for each missing font 122 (e.g., based on system resources or a similarity threshold).

Using the image(s) 312 for each missing font 122, the font comparison module 202 performs a visual search to find the similar fonts 212. For example, the font comparison module 202 uses a machine-learning model to perform the visual comparison and search for generating the list of similar fonts 212. The machine-learning model, for example, is a neural network specifically trained to learn the underlying patterns and structures of various fonts, including the fonts in the font library 112. Based on its training, the machine-learning model can compare the available fonts in the font library 112 to the missing fonts 122 in image 312 and provide an ordered or unordered list of similar fonts 212.

Using inputs of the missing fonts 122, the font metadata 210 with images 312, and the similar fonts 212, the layout comparison module 204 performs additional font comparisons taking text layout into account. For each missing font 122, the layout comparison module 204 assigns each font in the list of similar fonts 212 to one of two or more priority lists based on a font style match between the similar font 212 and the missing font 122 (block 404). In one implementation, the similar fonts 212 are assigned to one of two groups (e.g., List A and List B) based on a match between the font style of the missing font 122 and the similar fonts 212. For example, matching font styles are identified based on bold, italic, regular, semibold, or other visual characteristics. In another implementation, similar fonts 212 are not assigned to different groups but are placed in descending order based on the font-style match.

The layout comparison module 204 generates an image of the input layout with each similar font 212 (block 406). For each similar font 212, the layout comparison module 204 (or another component of the font replacement module 110) generates an image, preview, or screenshot of the similar font 212 applied to the same text as the missing font 122 in image 312.

For each similar font 212, the layout comparison module 204 determines a visual similarity metric between the generated image with the similar font 212 and the image 312 with the missing font 122 (block 408). The visual similarity is gauged using a mean square error image comparison technique due partly to its relatively fast computation time. In other implementations, the layout comparison module 204 uses another comparison technique (e.g., peak signal-to-noise ratio (PSNR) or structural similarity index metric (SSIM)). The visual similarity analysis attempts to preserve typesetting details from the original document, including kerning (e.g., spacing between individual pairs of characters), tracking or letter spacing (e.g., uniform adjustment of space between characters in a block of text), and line spacing or leading (e.g., spacing between individual lines of text).

In one implementation, blocks 406 and 408 are performed as parallel threads for each similar font 212. In another implementation, the layout comparison module 204 sequentially performs blocks 406 and 408. In another implementation, blocks 406 and 408 are performed in parallel for each similar font 212 in List A and then in parallel for the other similar fonts 212 in List B.

The layout comparison module 204 then assigns the similar fonts 212 to one of the two or more priority sub lists (e.g., List A1 and List A2) based on whether the text frame in the generated image is overset (block 410). For each similar font 212, the layout comparison module 204 determines whether the text was not overset with missing font 122 but overset with the similar font (or vice-versa). If an overset change occurred (e.g., based on the visual comparison), the similar font 212 is assigned to the lower sub list within its original priority list. For example, similar fonts are assignable to one of the following four sub lists: List A1 (e.g., no change in overset and visually similar fonts), List A2 (e.g., change in overset and visually similar fonts), List B1 (e.g., no change in overset and visually dissimilar fonts), and List B2 (e.g., change in overset and visually dissimilar fonts).

The layout comparison module 204 sorts the similar fonts 212 based on the visual similarity metric and the priority list assignment (block 412), which are provided to the font replacement module 110 as the suggested fonts 214 with corresponding similarity scores 216. For example, the similar font 212 with the highest similarity score within the highest priority list and sub list is presented as the top suggested font 214 with its corresponding similarity score 216. In another implementation, the similar fonts 212 are not ordered in priority lists or sub lists and ordered based on their visual similarity scores.

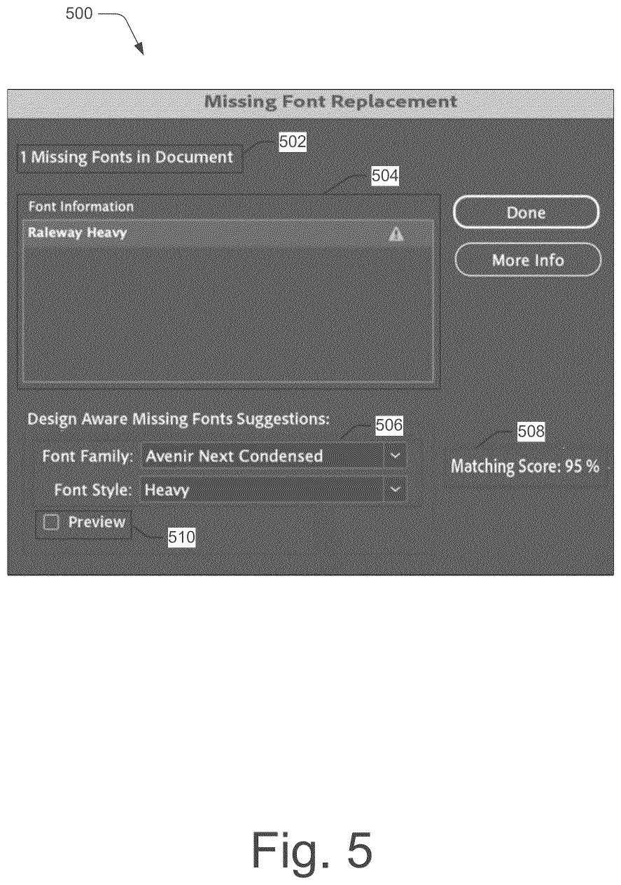

FIG. 5 illustrates an example user interface 500 for providing font replacement based on layout to a user. In the illustrated example, the user interface 500 is a dialog box that pops up as an application opens document 114. In other implementations, the user interface 500 is integrated into the menu or other visual elements associated with the application.

The user interface 500 provides the following information: a number of missing fonts 502, a listing of missing fonts 504, one or more suggested fonts 506, a matching score 508, and a preview option 510. In other implementations, the user interface 500 includes additional or fewer visual elements than illustrated in FIG. 5. The number of missing fonts 502 identifies a quantity of missing fonts 122. In this example, there is one missing font. The listing of missing fonts 504 provides a list, dropdown list, or other identification of each missing font. In the illustrated example, the missing font 122 is “Raleway Heavy.”

Based on a selection (by the user or by default by the processing device) of a missing font, the one or more suggested fonts 506 indicates one or more suggested fonts 214. In the illustrated example, the top suggested font 214 of “Avenir Next Condensed” with a font style of “Heavy” is initially displayed in the user interface 500. Other font styles and/or other suggested fonts 214 are available to the user via a drop-down list in user interface 500. In other examples, additional suggested fonts 214 are initially displayed and/or other visual elements are utilized to indicate the other suggested fonts 214. Based on the selection of the suggested font 214, the matching score 508 is updated to provide the corresponding similarity score 216. If the user selects a different font family and/or font style, the matching score 508 is updated to reflect the corresponding similarity score 216. Preview option 510 allows the user to preview the currently selected suggested font 214. In one example, the preview includes the image 312 of the missing font 122 and the generated image with the suggested font 214 to allow the user to make a visual comparison before confirming the current font as the replacement font.

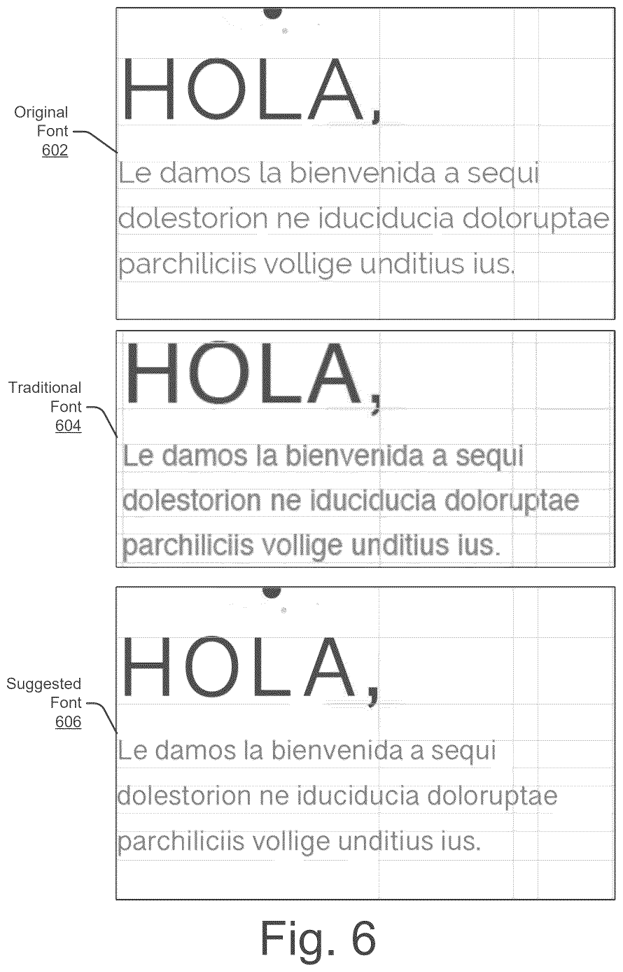

FIGS. 6 through 13 illustrate comparisons of traditional substitution suggestions versus layout-based font replacement suggestions for missing fonts compared to the original document's missing font. In particular, FIGS. 6 through 13 provide example screenshots taken from different documents with different original or missing fonts. Each figure provides a screenshot of the initial layout with the original font applied, followed by applying the best font using traditional replacement techniques and the top suggested font using the described design-aware substitution suggestions for missing fonts.

In FIG. 6, the original font 602 is Raleway Regular. The traditional font 604 identified using traditional techniques is Myriad Pro Regular. As visually illustrated, the traditional font 604 has a different style than the original font 602. In addition, the paragraph text in black (e.g., below “HOLA”) is heavier due to the font change, which impacts the layout and design of the paragraph. In contrast, the suggested font 606 is Myanmar Sangam MN Regular. The paragraph text's layout and design are consistent with the original font 602. In particular, the font size, line spacing, word spacing, and text composition are quite similar between the original font 602 and the suggested font 606 because the font replacement module 110 performed a visual comparison in light of the design layout.

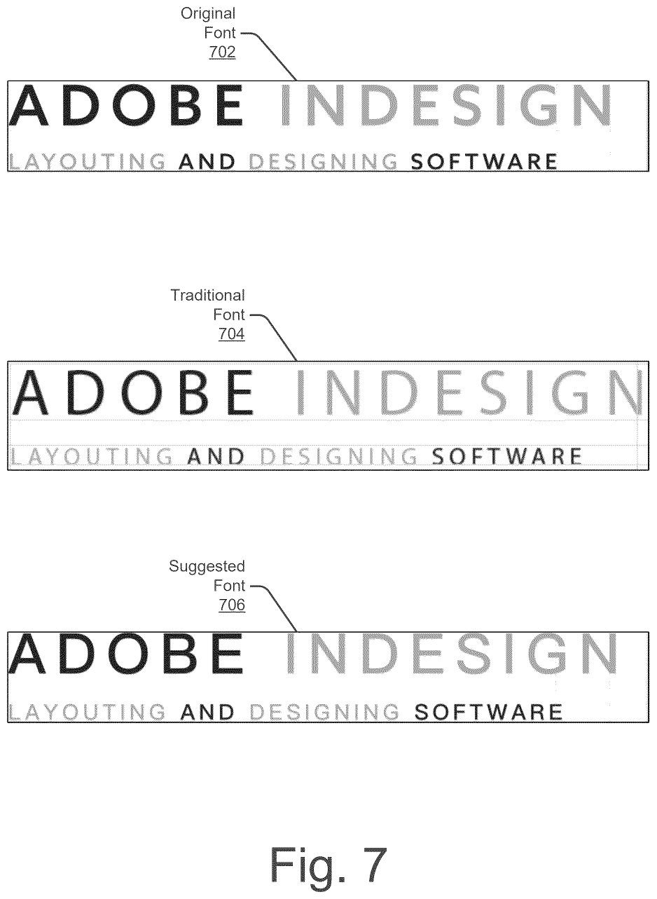

In FIG. 7, the original font 702 is Azo Sans Medium. The traditional font 704 identified using traditional techniques is Myriad Pro Regular. As visually illustrated, the traditional font 704 has a larger line height with increased line space compared to the original font 702. In addition, the traditional font 704 appears to have a different style than the original font 702. In contrast, the suggested font 706 is PingFang HK Medium. The paragraph text's layout is more consistent with the original font 702, with negligible impact on the design layout.

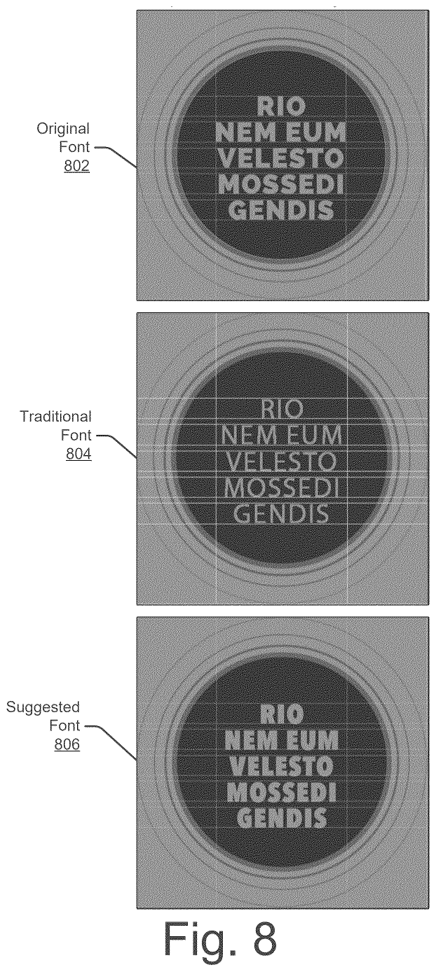

In FIG. 8, the original font 802 is Raleway Heavy. The traditional font 804 identified using traditional techniques is Myriad Pro Regular. As visually illustrated, the traditional font 804 has a lighter style than the original font 802. In addition, the paragraph text has narrower line widths than the original font 802. In contrast, the suggested font 806 is Avenir Next Condensed Heavy. The text's layout and design are consistent with the original font 802. In particular, the font size, line spacing, word spacing, and text composition are quite similar between the original font 802 and the suggested font 806 because the font replacement module 110's visual comparison.

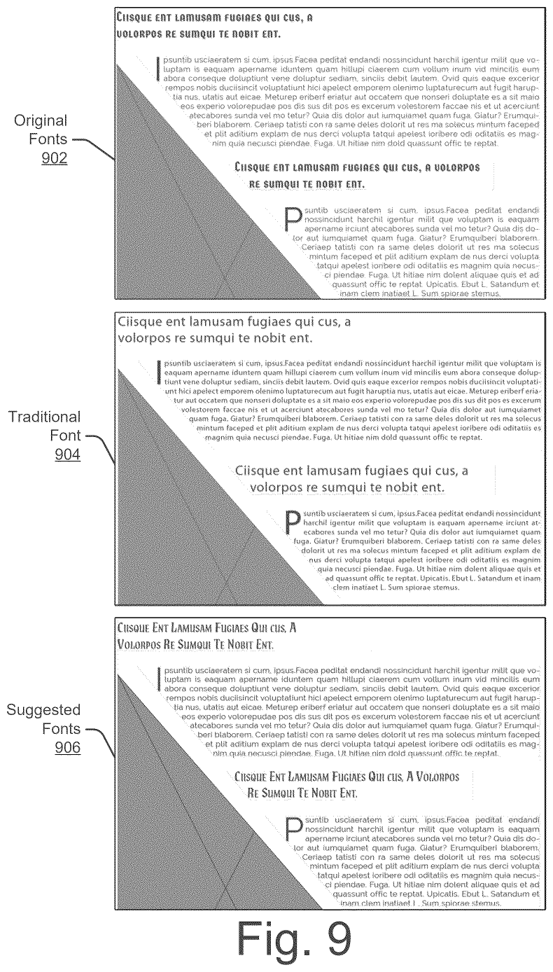

In FIG. 9, the design is made of four text frames, with the first one having a rectangular shape and the other three having trapezoidal shapes. The original fonts 902 are Cinder Regular for the headings and Raleway Regular for the paragraph text. The traditional font 904 loses the gothic styling for the headings and changes the number of lines in the paragraphs. As visually illustrated, the traditional font 904 has changed the overall style of the document. In contrast, the suggested fonts 906 are BC Vagar for the headings and Khmer Sangam MN Regular for the paragraph text. The gothic styling for the headings and the number of paragraph lines are preserved.

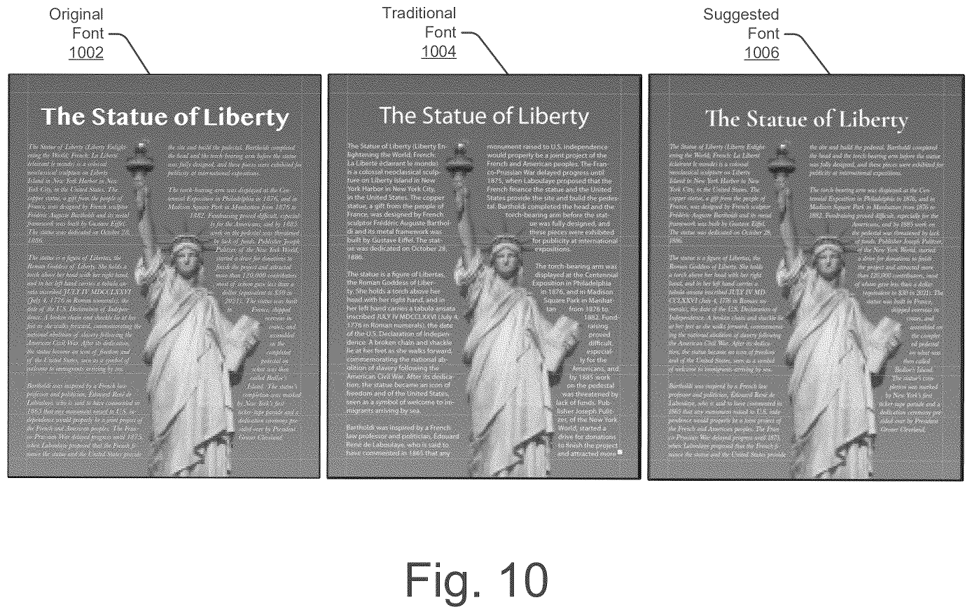

In FIG. 10, the original font 1002 is Baskerville Italic. The traditional font 1004 identified using traditional techniques is Myriad Pro Regular. As visually illustrated, the traditional font 1004 causes the text to overset within the original text frame. In contrast, the suggested font 1006 is Marion Italic. The text does not overset and the paragraphs use the same number of lines. In particular, the font size, line spacing, word spacing, and text composition are quite similar between the original font 1002 and the suggested font 1006.

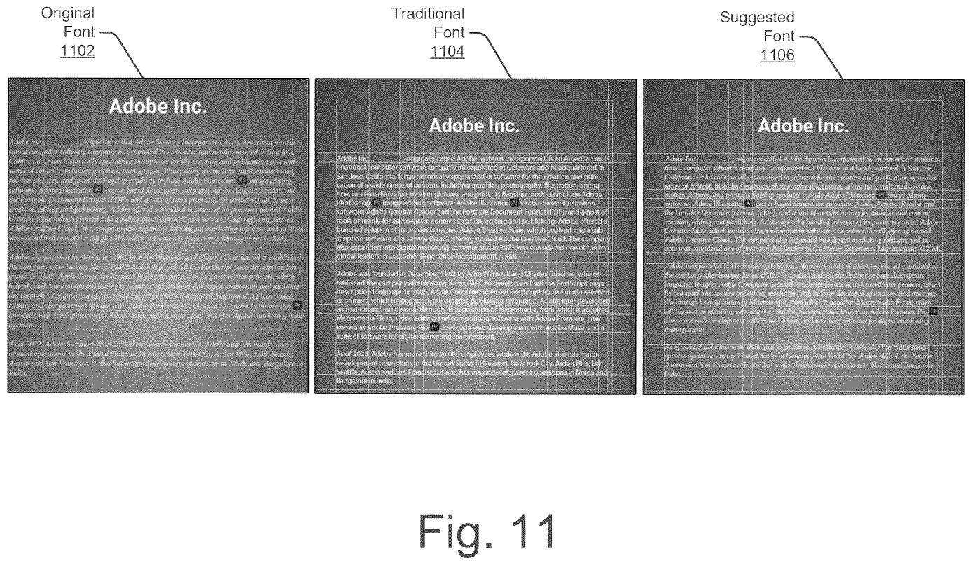

In FIG. 11, the original font 1102 is Minion Pro Italic. The traditional font 1104 identified using traditional techniques is Adobe Hebrew Italic. As visually illustrated, the traditional font 1104 causes the inline objects to shift. For example, the Ps and Ai icons are shifted to the right and the Pr icon is shifted to the next line. Each paragraph takes up an extra line. In contrast, the suggested font 1106 is OFL Sorts Mill Goudy Italic. The inline objects shift much less, with the Ai icon not shifting and the Ps and Pr icons shifting slightly from their original locations. The paragraphs occupy the same number of lines as with the original font 1102.

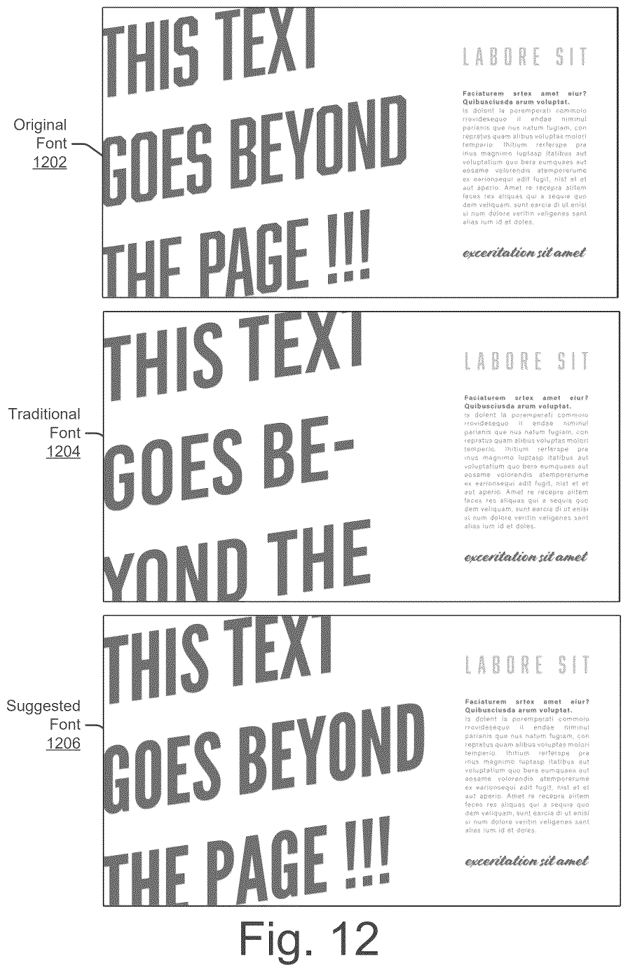

In FIG. 12, the original font 1202 is Abolition Regular. The traditional font 1204 identified using traditional techniques is Bebas Kai Regular. As visually illustrated, the traditional font 1204 causes overset and the word “PAGE” are not within the text frame. In addition, the word “BEYOND” spans multiple lines. In contrast, the suggested font 1206 is League Gothic Regular. The text takes up the same space as in the original document. Even with the askance text box, the font size, line spacing, word spacing, and text composition are similar between the original font 1202 and the suggested font 1206.

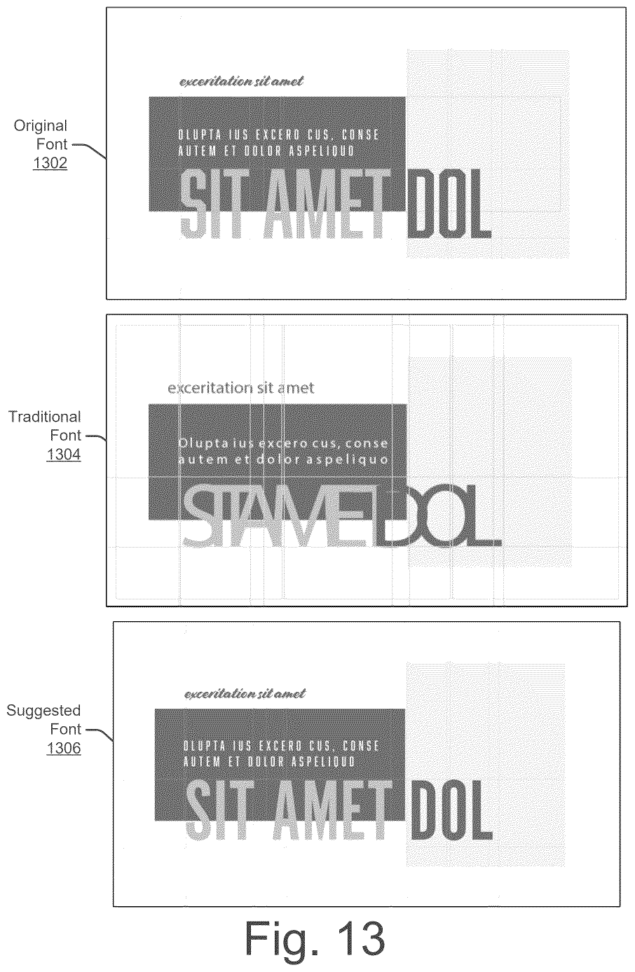

In FIG. 13, the original font 1302 is Abolition Regular. The traditional font 1304 identified using traditional techniques is Myriad Pro Regular. As visually illustrated, the traditional font 1304 has wider glyphs and reduced glyph spacing, causing the characters in the larger text to overlap. In contrast, the suggested font 1306 is Alternate Gothic No1 D Regular. The spacing and widths of the glyphs is very similar to those using the original font 1302.

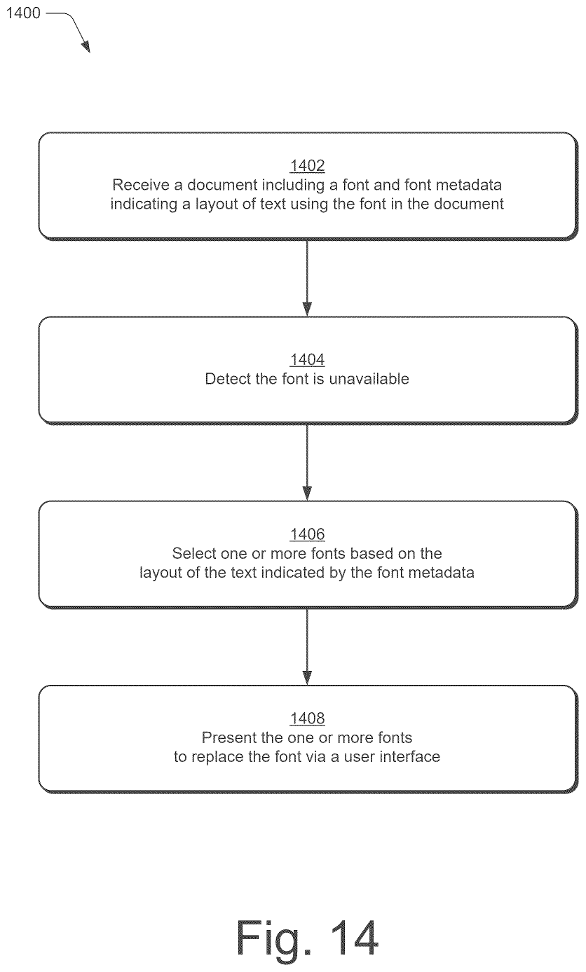

FIG. 14 is a flow diagram depicting a procedure 1400 in an example implementation for font replacement based on layout. A document with a font and font metadata is received (block 1402). The font metadata indicates a layout of text using the font in the document. For example, the font metadata 210 includes a screenshot (e.g., image 312) of a region of document 114 using a corresponding font. The region for each font includes, in order of size preference, a paragraph, line, or word (solely) using the font and is determined or identified based on at least one of font size, character count, word count, or usage area. The font metadata 210, including images 312, is created when document 114 is saved by a different computing device or a different application than the computing device or the application opening document 114. In some implementations, the font metadata 210 also includes physical bounds of the associated text in the prominent region.

The font is detected as unavailable or missing (block 1404). For example, the font replacement module 110 identifies the one or more missing fonts 122. One or more (suggested) fonts to replace the font are selected based on the layout of the text indicated by the font metadata (block 1406).

For example, a font comparison module 202 uses a machine-learning model to determine one or more similar fonts 212 for each missing font 122 that are visually similar to the missing font 122. A layout comparison module 204 generates, for each similar font 212, a replacement image of the portion of document 114 using the similar font 212. The imaged portion corresponds to the image(s) 312 included in the font metadata 210 for the missing font 122. The layout comparison module 204 uses a visual comparison technique (e.g., a mean square error technique) to determine a visual similarity metric between the replacement image using the similar font 212 and the image(s) 312 using the missing font 122. The visual similarity metric or similarity score 216 assesses differences in at least one of kerning, letter spacing, line spacing, and oversetting. The layout comparison module 204 also sorts the similar fonts 212 into one or more sorted similar fonts based on the visual similarity metric. In one implementation, the suggested fonts 214 for each missing font 122 are determined as a threshold number (e.g., top ten) of sorted similar fonts 212. In another implementation, the suggested fonts 214 for each missing font 122 are determined as the sorted similar fonts 212 with a corresponding visual similarity metric or similarity score 216 above a threshold metric value (e.g., above 80%).

In one example, the user interface 500 includes an indication of a matching score 508 for each suggested font 506. The user interface 500 sorts the suggested fonts 506 for each missing font 504 based on the matching score 508 for each suggested font 506. In at least one implementation, the user interface 500 includes a preview option allowing users to visually preview the updated document 118 that replaces the missing font 122 with a user-selected replacement font.

The one or more suggested fonts are presented via a user interface for replacing the font (block 1408). For example, the updated document is presented via the user interface as replacing the font based on a selection of the one or more suggested fonts.

### Example System and Device

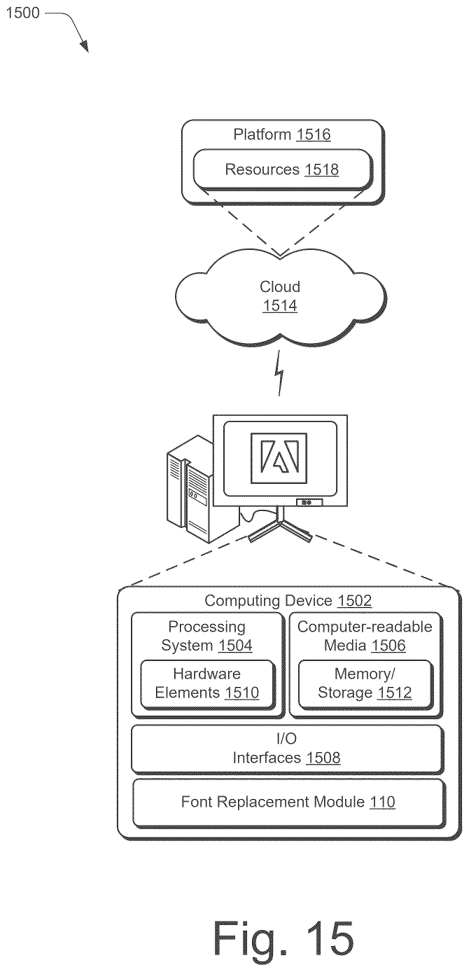

FIG. 15 illustrates an example system 1500 that includes an example computing device that is representative of one or more computing systems and/or devices that are usable to implement the various techniques described herein. This is illustrated through inclusion of the font replacement module 110. The computing device 1502 includes, for example, a server of a service provider, a device associated with a client (e.g., a client device), an on-chip system, and/or any other suitable computing device or computing system.

The example computing device 1502 as illustrated includes a processing system 1504, one or more computer-readable media 1506, and one or more I/O interfaces 1508 that are communicatively coupled, one to another. Although not shown, the computing device 1502 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1504 is representative of functionality to perform one or more operations using hardware. Accordingly, the processing system 1504 is illustrated as including hardware elements 1510 that are configured as processors, functional blocks, and so forth. This includes example implementations in hardware as an application specific integrated circuit or other logic device formed using one or more semiconductors. The hardware elements 1510 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1506 is illustrated as including memory/storage 1512. The memory/storage 1512 represents memory/storage capacity associated with one or more computer-readable media. In one example, the memory/storage 1512 includes volatile media (such as random access memory (RAM)) and/or nonvolatile media (such as read only memory (ROM), Flash memory, optical disks, magnetic disks, and so forth). In another example, the memory/storage 1512 includes fixed media (e.g., RAM, ROM, a fixed hard drive, and so on) as well as removable media (e.g., Flash memory, a removable hard drive, an optical disc, and so forth). The computer-readable media 1506 is configurable in a variety of other ways as further described below.

Input/output interface(s) 1508 are representative of functionality to allow a user to enter commands and information to computing device 1502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1502 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1502. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1502, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1510 and computer-readable media 1506 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1510. For example, the computing device 1502 is configured to implement particular instructions and/or functions corresponding to the software and/or hardware modules. Accordingly, implementation of a module that is executable by the computing device 1502 as software is achieved at least partially in hardware, e.g., through use of computer-readable storage media and/or hardware elements 1510 of the processing system 1504. The instructions and/or functions are executable/operable by one or more articles of manufacture (for example, one or more computing devices 1502 and/or processing systems 1504) to implement techniques, modules, and examples described herein.

The techniques described herein are supportable by various configurations of the computing device 1502 and are not limited to the specific examples of the techniques described herein. This functionality is also implementable entirely or partially through use of a distributed system, such as over a “cloud” 1514 as described below.

The cloud 1514 includes and/or is representative of a platform 1516 for resources 1518. The platform 1516 abstracts underlying functionality of hardware (e.g., servers) and software resources of the cloud 1514. For example, the resources 1518 include applications and/or data that are utilized while computer processing is executed on servers that are remote from the computing device 1502. In some examples, the resources 1518 also include services provided over the Internet and/or through a subscriber network, such as a cellular or Wi-Fi network.

The platform 1516 abstracts the resources 1518 and functions to connect the computing device 1502 with other computing devices. In some examples, the platform 1516 also serves to abstract scaling of resources to provide a corresponding level of scale to encountered demand for the resources that are implemented via the platform. Accordingly, in an interconnected device embodiment, implementation of functionality described herein is distributable throughout the system 1500. For example, the functionality is implementable in part on the computing device 1502 as well as via the platform 1516 that abstracts the functionality of the cloud 1514.

Although implementations of systems for frame interpolation of motion graphics have been described in language specific to structural features and/or methods, it is to be understood that the appended claims are not necessarily limited to the specific features or methods described. Rather, the specific features and methods are disclosed as example implementations of systems for frame interpolation of motion graphics, and other equivalent features and methods are intended to be within the scope of the appended claims. Further, various different examples are described and it is to be appreciated that each described example is implementable independently or in connection with one or more other described examples.

What is claimed is:

1. A method comprising:
receiving, by a processing device, a document including a font and font metadata, the font metadata indicating a layout of text using the font in the document;
detecting, by the processing device, that the font is unavailable;
selecting, by the processing device, one or more fonts from a plurality of fonts based on the layout of the text indicated by the font metadata; and
presenting, by the processing device via a user interface, the one or more fonts to replace the font as used for the text in the document.

2. The method of claim 1, further comprising presenting the document in the user interface as replacing the font based on a selection of the one or more fonts.

3. The method of claim 1, wherein the font metadata indicates the layout of the text through at least one of kerning, letter spacing, line spacing, or oversetting.

4. The method of claim 1, wherein the font metadata further includes an image of a region of the document that includes the font.

5. The method of claim 4, wherein the region includes a paragraph, line, or word using the font and is selected for inclusion in the font metadata based on at least one of font size, character count, word count, or usage area of the font in the region.

6. The method of claim 1, wherein selecting the one or more fonts includes determining visual similarity of the font to the plurality of fonts using a machine-learning model.

7. The method of claim 6, wherein the determining further comprises:
generating, for each of the plurality of fonts, a replacement image of a region of the document using a respective said font; and
determining, using a visual comparison technique, a visual similarity metric between the replacement image for each of the plurality of fonts and an image of the region.

8. The method of claim 7, wherein the visual comparison technique assesses differences in the layout of text in the replacement image and the image of the region using a mean square error technique.

9. A system comprising:
a memory component; and
one or more processing devices coupled to the memory component, the one or more processing devices to perform operations including:
receiving a document including a font and an image of a region of the document using the font;
detecting that the font is unavailable;
determining one or more fonts based on a visual similarity between the image of the region and a replacement image of the region using one or more fonts from a plurality of fonts that are available; and
presenting, via a user interface, the one or more fonts to replace the font.

10. The system of claim 9, wherein:
the image is captured as a screenshot of the region; and
the determining of visual similarity is performed using a machine-learning model based on the image and the replacement image.

11. The system of claim 9, wherein the operations further comprise sorting the plurality of fonts based on the visual similarity.

12. The system of claim 11, wherein the visual comparison technique is a mean square error technique that is configured to assess a difference in at least one of kerning, letter spacing, line spacing, or oversetting.

13. One or more computer-readable storage media storing instructions that, responsive to execution by a processing device, causes the processing device to perform operations including:
receiving a document including a font and font metadata, the font metadata indicating a layout of text using the font in the document;
detecting that the font is unavailable;
selecting one or more fonts from a plurality of fonts based on the layout of the text indicated by the font metadata; and
presenting, in a user interface, the one or more fonts to replace the font as used for the text in the document.

14. The one or more computer-readable storage media of claim 13, wherein the operations further comprise presenting the document in the user interface as replacing the font based on a selection of the one or more fonts received via the user interface.

15. The one or more computer-readable storage media of claim 13, wherein the font metadata indicates the layout of the text through at least one of kerning, letter spacing, line spacing, or oversetting.

16. The one or more computer-readable storage media of claim 13, wherein the font metadata includes an image of a region of the document that includes the font.

17. The one or more computer-readable storage media of claim 16, wherein the region includes a paragraph, line, or word using the font and is selected for inclusion in the font metadata based on at least one of font size, character count, word count, or usage area of the font in the region.

18. The one or more computer-readable storage media of claim 13, wherein the selecting includes determining visual similarity of the font to the plurality of fonts using a machine-learning model.

19. The one or more computer-readable storage media of claim 18, wherein the determining further comprises:
generating a replacement image of a region of the document using a respective font from the plurality of fonts; and
determining, using a visual comparison technique, a visual similarity metric between the replacement image and an image of the region.

20. The one or more computer-readable storage media of claim 19, wherein the visual comparison technique assesses differences in the layout of text in the replacement image and the image of the region using a mean square error technique.
